(19) United States
(12) Patent Application Publication
(10) Pub. No.: US 2006/0152670 A1
(43) Pub. Date: Jul. 13, 2006

(54) Opti-clip

(76) Inventor: John Solomon Esparza, Collinsville, IL (US)

Correspondence Address: John Solomon Esparza, 150 South Aurora Street, Collinsville, IL, 62234, US

(21) Appl. No.: 11/033,667

(22) Filed: Jan. 12, 2005

(51) Int. Cl. G02C 5/00

(52) U.S. Cl. 351/41

(57) ABSTRACT

A plastic or metal alligator clip 1 inch long and 3/16 inch wide glued or factory installed onto base of right or left eye glass temple, so that when compressed will open to be clamped onto the top of a shirt or coat breast pocket. The plastic spring loaded clip may end up being produced of a die-injected polyethylene plastic that incorporates soft rubber compounds. This type of material provides a product that requires no painting and provides easy finger gripping surfaces.

### DESCRIPTION OF MANUFACTURED EYE GLASS FRAME WITH FACTORY INSTALLED OPTI-CLIP

FIG. 1A shows top view of outer right side eye glass temple.

FIG. 1B shows side view of outer side of right eye glass temple.

FIG. 1C shows side view of right side eye glass temple.

FIG. 2A shows opti-clip.

FIG. 2B shows side view of spring loaded opti-clip.

FIG. 2C shows side view of factory installed opti-clip compressed.

### DESCRIPTION OF SEVERAL VIEWS OF THE DRAWINGS. CONSUMER INSTALLED.

FIG. 1A shows side view of a plastic alligator clip 1 inch long and 3/16 inch wide.

FIG. 1B shows small tube containing 0.08 oz (2.5 g) of plastic cement glue.

FIG. 2A shows left eye glass temple being prepared by having plastic cement glue applied to outside of temple.

FIG. 2B shows top view of alligator clip and same being glued in place.
Note: alligator clip must point toward ear support of left eye glass temple.

FIG. 3A shows eye glasses with opti-clip in use to secure glasses to shirt breast pocket.

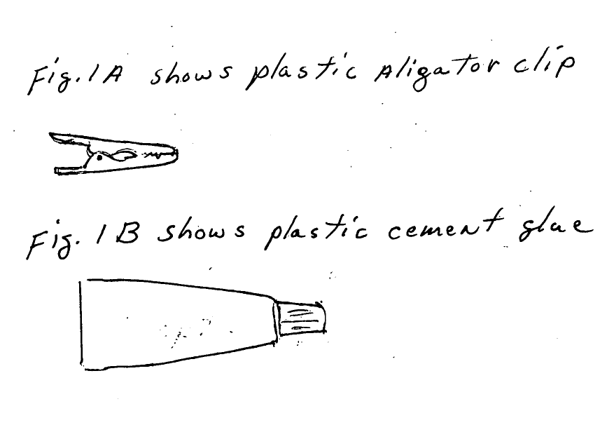

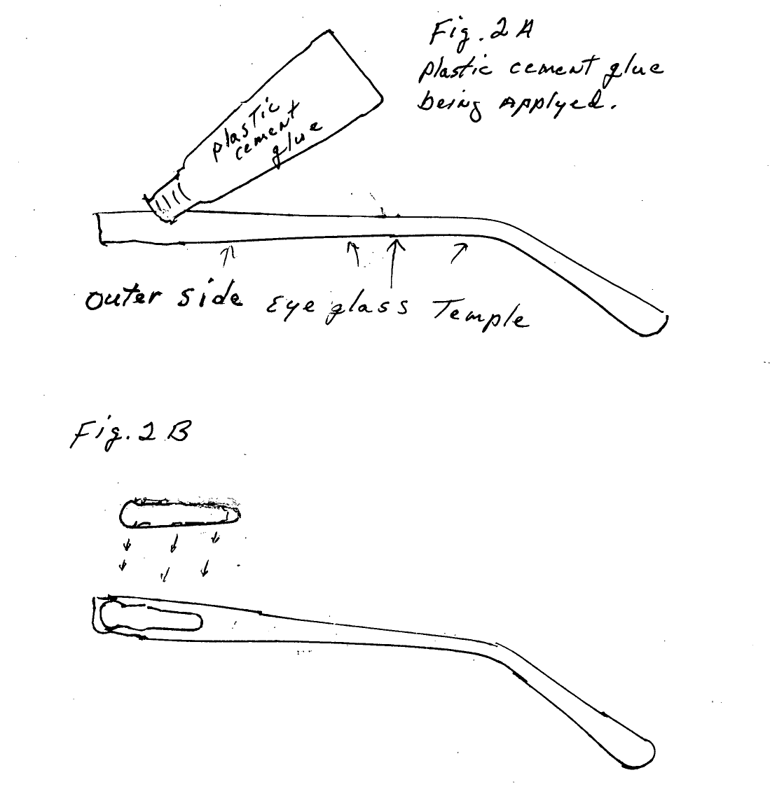

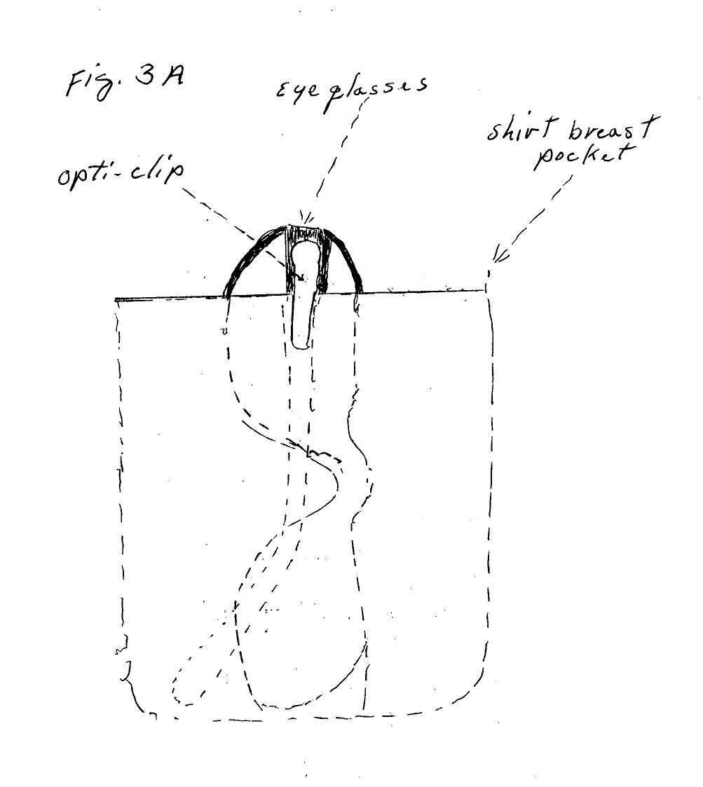

This invention relates to eye glasses specifically to an improved method of carrying eye glasses so that they will not fall out of ones pocket.

This method consists of a plastic or metal spring clip known as an alligator clip. This clip being one inch long, and three sixteenth of an inch wide. It attached to the base of the right or left eye glass temple. Thereby allowing one to carry eye glasses in a shirt or coat breast pocket.

Reading and sunglasses are often carried in a shirt or coat breast pocket. Most times these eye glasses fall out of our pockets and break or become lost as we lean over.

Optical companies commonly supply consumers with eye glass cases that have a slide clip: Magnivision, Miramar Fla., 33025. Such cases do serve a purpose when shipping and storing eye glasses.

However, consumers object since these cases are to cumbersome to carry.

Accordingly, the objects and advantages of my invention are to provide a way to carry ones eye glasses without fear of loss or damage, and meet the convenience desired by the consumer with having ones eye glasses at available at your fingertips.

Manufacturers of eye class frames can install the opti-clip in various colors to match eye glass frames.

The use of these opti-clips will prove to be very helpful to workers in all fields where reading and sunglasses are needed intermittently.

What I claim as my invention is:

1. A method of securing eye glasses to shirt or coat breast pocket.
